(19) United States
(12) Patent Application Publication
(10) Pub. No.: US 2015/0192677 A1
(43) Pub. Date: Jul. 9, 2015

(54) DISTRIBUTED LIDAR SENSING SYSTEM FOR WIDE FIELD OF VIEW THREE DIMENSIONAL MAPPING AND METHOD OF USING SAME

(71) Applicants: TIANYUE YU, SUNNYVALE, CA (US); ANGUS PACALA, PALO ALTO, CA (US); LOUAY ELDADA, SUNNYVALE, CA (US)

(72) Inventors: TIANYUE YU, SUNNYVALE, CA (US); ANGUS PACALA, PALO ALTO, CA (US); LOUAY ELDADA, SUNNYVALE, CA (US)

(73) Assignee: QUANERGY SYSTEMS, INC., SUNNYVALE, CA (US)

(21) Appl. No.: 14/147,496

(22) Filed: Jan. 3, 2014

(51) Int. Cl. G01S 17/93

(52) U.S. Cl. CPC G01S 17/936

(57) ABSTRACT

A three-dimensional mapping system comprising a moderate number (typically 2 to 4) of moderate-beam-count (typically 8-beam to 16-beam) lidar sensors is proposed to achieve low cost systems with wide fields of view. Secondary advantages include compact sensors and a small minimum range (possible by optimal placement of each of a plurality of sensors).

### RELATED U.S. APPLICATION DATA

The present application claims the benefit of priority from U.S. Provisional Application Ser. No. 61/748,748, filed Jan. 3, 2013. Other related U.S. application is U.S. Provisional Application Ser. No. 61/726,538, filed Nov. 14, 2012.

### REFERENCES CITED

### U.S. Patent Documents

| | | |
|---|---|---|
| 5,455,669 | October 1995 | Wetteborn |
| 7,746,449 B2 | June 2010 | Ray |
| 7,969,558 B2 | June 2011 | Hall |
| 2011/0216304 A1 | September 2011 | Hall |

### FIELD OF THE INVENTION

The present invention relates generally to the field of vehicle-based three-dimensional mapping, and more particularly to the use of distributed time-of-flight lidar sensing systems for real-time wide-field-of-view three-dimensional mapping of the space surrounding a vehicle.

### BACKGROUND OF THE INVENTION

A lidar sensor is a light detection and ranging sensor. It is an optical remote sensing module that can measure the distance to a target or objects in a landscape, by irradiating the target or landscape with light, using pulses from a laser, and measuring the time it takes photons to travel to said target or landscape and return after reflection to a receiver in the lidar module. In the field of lidar mapping, the three-dimensional rendering of a landscape and the recognition of objects are traditionally achieved through the use of a single lidar sensor with a large number of transmitter-receiver pairs (per cited Hall references), or the use of a large number of sensors having a single transmitter-receiver pair (per cited Wetteborn and Ray references). These traditional approaches are prohibitively expensive. High cost has been one of the main reasons behind the lack of broadly-deployed commercial lidar solutions for consumers.

### SUMMARY OF THE INVENTION

A three-dimensional mapping system comprising a moderate number (typically 2 to 4) of moderate-beam-count (typically 8-beam to 16-beam) lidar sensors is proposed to achieve low cost systems with wide fields of view. Secondary advantages include compact sensors and a small minimum range (possible by optimal placement of each of a plurality of sensors).

### BRIEF DESCRIPTION OF THE DRAWINGS

The following drawings are illustrative of embodiments of the present invention and are not intended to limit the invention as encompassed by the claims forming part of the application.

The schematic diagram of FIG. 1 depicts a vehicle with mapping capability with examples of potential positions for the mounting of lidar sensors. The mounting can be done on the side view mirror fixtures 10, between the rear view mirror and the windshield 20, on the headlight fixtures 30, on the bumpers 40, in front of or behind the grill 50, on the hood 60, on the trunk 70 and/or on the roof 80. Each of the plurality of lidars in the current invention can be mounted in any location on a vehicle; the location options are not limited to the ones depicted in FIG. 3.

The schematic diagram of FIG. 2 provides an external view of a compact lidar sensor 100 that can be used in the present invention, depicting a static base 110 and a static head assembly 120 that includes a window 130 that is transparent at the wavelength of the laser used in each transmitter.

FIG. 3 provides an external and internal view of one type of lidar that can be used in the present invention, depicting an internal spinning turret 140.

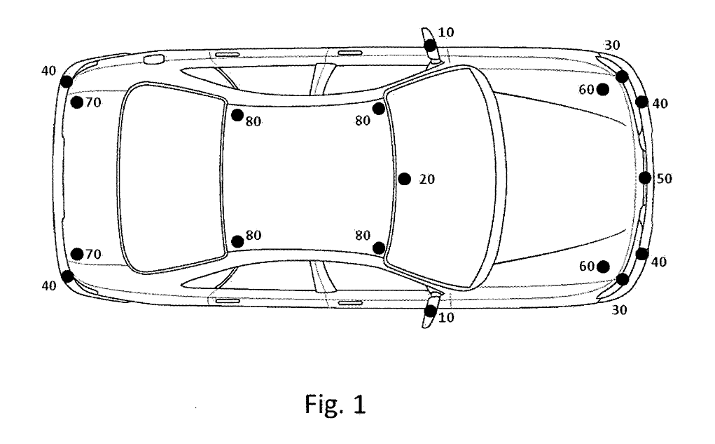

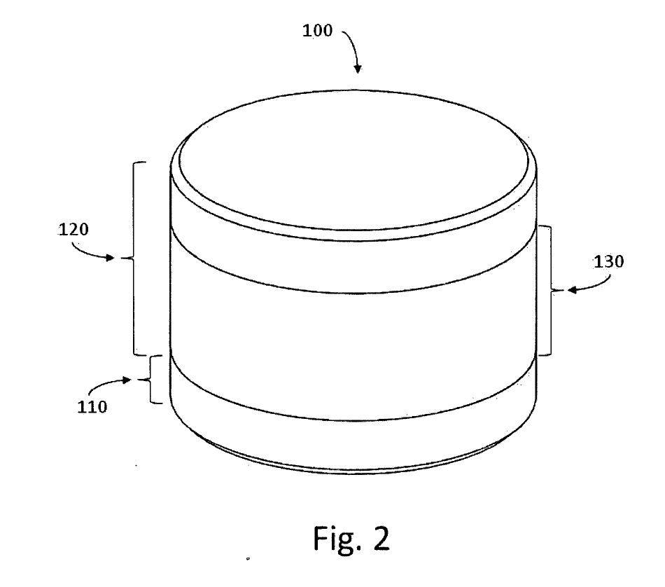

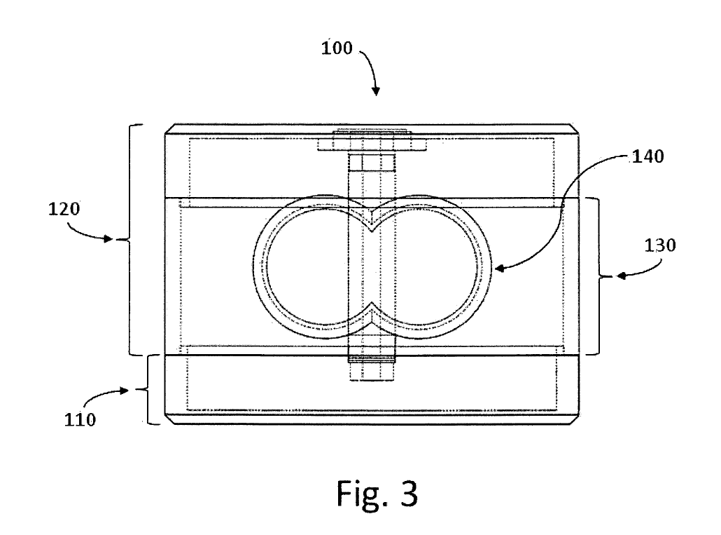

### DETAILED DESCRIPTION OF THE INVENTION

The proposed apparatus and related method are used for real-time wide-field-of-view three-dimensional mapping using a moderate number (typically 2 to 6) time-of-flight lidar sensors, each containing a moderate number of transmitter-receiver pairs (typically 4 to 16) and a mechanism to scan each laser beam of each transmitter horizontally and vertically, as well as central data processing electronics.

Primary advantages of these systems include low cost and wide field of view. Secondary advantages include compact sensors and a small minimum range made possible by optimal placement of each of a plurality of sensors.

Each sensor features multi-dimensional scanning and a high sampling rate, enabling the collection of rich data capable of supporting high-resolution three-dimensional mapping and object recognition.

The present invention also includes mutual calibration of the plurality of time-of-flight lidar sensors, arbitrary mounting angle, automated leveling of the sensors, ranging in different planes, as well as the flexibility of unique mounting positions when installed (e.g., in a vehicle, the mounting can be done on the side view mirror fixtures, between the rear view mirror and the windshield, on the headlight fixtures, on the bumpers, in front of or behind the grill, on the hood, on the trunk and/or on the roof).

What is claimed is:

1. A wide-field-of-view time-of-flight lidar apparatus comprising:
a) a plurality of time-of-flight lidar sensors;
b) a plurality of optical transmitter-receiver pairs per lidar sensor;
c) a mechanism to scan the laser beam of each transmitter horizontally and vertically;
d) central data processing electronics.

2. The apparatus of claim 1 comprising no more than six lidar sensors.

3. The apparatus of claim 1 comprising no more than three lidar sensors.

4. The apparatus of claim 1 wherein each of said plurality of time-of-flight lidar sensors comprises no more than sixteen transmitter-receiver pairs.

5. The apparatus of claim 1 wherein each of said plurality of time-of-flight lidar sensors comprises no more than eight transmitter-receiver pairs.

6. The apparatus of claim 1 wherein said field of view is 360 degrees.

7. The apparatus of claim 1 wherein said field of view is smaller than 360 degrees and larger than 180 degrees.

8. The apparatus of claim 1 wherein each transmitter-receiver pair comprises at least one of the following:
a) an infrared laser;
b) a visible-spectrum laser;
c) an ultraviolet laser;
d) an avalanche photodiode detector;
e) a positive-intrinsic-negative diode detector.

9. The apparatus of claim 1 wherein each transmitter-receiver pair operates at a sampling rate of at least 10 KHz.

10. The apparatus of claim 1 wherein each transmitter-receiver pair operates at a sampling rate of at least 100 KHz.

11. The apparatus of claim 1 wherein each transmitter-receiver pair operates at a sampling rate of at least 1 MHz.

12. The apparatus of claim 1 wherein said mechanism for horizontal and vertical laser beam scanning comprises at least one platform rotating in two axes.

13. The apparatus of claim 1 wherein said mechanism for horizontal and vertical laser beam scanning comprises at least one platform rotating in an essentially horizontal plane and at least one vertical beam steering element.

14. The apparatus of claim 13 wherein said mechanism for horizontal and vertical laser beam scanning results in a serpentine scanning pattern.

15. The apparatus of claim 14 wherein said serpentine scanning pattern is essentially sinusoidal.

16. The apparatus of claim 13 wherein said vertical beam steering element operates based on rotation.

17. The apparatus of claim 13 wherein said vertical beam steering element operates based on oscillation.

18. The apparatus of claim 17 wherein said beam steering element comprises an oscillating reflective surface.

19. The apparatus of claim 17 wherein said beam steering element comprises an oscillating component that achieves essentially total internal reflection.

20. The apparatus of claim 17 wherein said beam steering element operates based on a change in the refractive index of a medium traversed by said beam.

21. The apparatus of claim 17 wherein said beam steering element operates based on diffraction.

22. The apparatus of claim 17 wherein said beam steering element operates based on phased-array optics.

23. The apparatus of claim 17 comprising at least one of the following:
a) a mirror;
b) a gimbal;
c) a prism;
d) a lens;
e) a grating;
f) a phased array.

24. The apparatus of claim 17 wherein said beam steering element comprises at least one of the following:
a) a mirror-based microelectromechanical system;
b) a mirror-oscillating galvanometer;
c) a mirror-based gimbal;
d) a Risley prism;
e) an oscillating diffraction grating;
f) a tunable diffraction grating;
g) a lens with a tunable refractive index;
h) a tunable optical phased array;

25. The apparatus of claim 1 wherein the plurality of time-of-flight lidar sensors:
a) are mutually calibrated;
b) have data streams that are fused by said central processing electronics to form one data stream representing a wide view of the space surrounding said apparatus.

26. The apparatus of claim 25 wherein said wide-view data stream is coupled to a human-machine interface that performs any subset of:
(a) displaying said data stream;
(b) interpreting said data stream;
(c) displaying environment awareness data;
(d) providing visual, auditory and/or tactile cues.

27. The apparatus of claim 26 used in a ground transportation vehicle, wherein said environment awareness data include any subset of:
(a) location of car and trucks;
(b) locations of motorcyclists and cyclists;
(d) location of pedestrians;
(e) location of animals;
(f) location of stationary objects.

28. The apparatus of claim 26 used in a ground transportation vehicle, wherein said auditory and/or visual cues warn to hazards, including any subset of:
(a) obstacles in blind spots;
(b) lane departure;
(c) unsafe following distance;
(d) sudden changes in traffic flow;
(e) approaching vehicles at intersections;
(f) approaching obstacles when backing up;
(g) debris on road;
(h) hazardous road conditions including but not limited to potholes, cracks and bumps;
(i) hazardous weather conditions.

29. The apparatus of claim 26 used in a ground transportation vehicle, wherein said displaying of data stream is done on any of the following:
(a) a smartphone display;
(b) a tablet display;
(c) an infotainment system display;
(d) a navigation system display;
(e) a display built into the dashboard of said vehicle;
(f) a head-up display;
(g) a display built into the steering wheel of said vehicle.

30. The apparatus of claim 1 wherein at least one time-of-flight lidar sensor has a data stream representing ranging in a plane that is different from the plane(s) ranged by other lidar sensor(s).

31. The apparatus of claim 30 wherein each time-of-flight lidar sensor ranges in a unique plane.

32. The apparatus of claim 1 wherein at least one of the plurality of time-of-flight lidar sensors is located at one of the following positions of a ground transportation vehicle:
(a) on a side view mirror fixture;
(b) between the rear view mirror and the windshield;
(c) on a headlight fixture;
(d) on a bumper;
(e) in front of the grill;
(f) behind the grill;
(g) on the hood;
(h) on the trunk;
(i) on the roof.

33. The apparatus of claim 1 wherein at least one of said plurality of time-of-flight lidar sensors has the capability to be mounted at a wide range of angles.

34. The apparatus of claim 33 wherein said at least one lidar sensor having the capability to be mounted at a wide range of angles has inverted mounting capability.

35. The apparatus of claim 33 wherein said at least one lidar sensor having the capability to be mounted at a wide range of angles has the capability to achieve self leveling.

36. A method for wide-field-of-view ranging utilizing a time-of-flight lidar apparatus comprising:
a) a plurality of time-of-flight lidar sensors;
b) a plurality of optical transmitter-receiver pairs per lidar sensor;
c) a mechanism to scan the laser beam of each transmitter horizontally and vertically;
d) central data processing electronics.

37. The method of claim 36 wherein said plurality of time-of-flight lidar sensors in said apparatus:
a) are mutually calibrated;
b) have data streams that are fused by said central processing electronics to form one data stream representing a wide view of the space surrounding said apparatus.

38. The method of claim 36 wherein at least one of said plurality of time-of-flight lidar sensors in said apparatus has a data stream representing ranging in a plane that is different from the plane(s) ranged by other lidar sensor(s).

39. The method of claim 36 wherein at least one of the plurality of time-of-flight lidar sensors in said apparatus is located at one of the following positions of a ground transportation vehicle:
(a) on a side view mirror fixture;
(b) between the rear view mirror and the windshield;
(c) on a headlight fixture;
(d) on a bumper;
(e) in front of the grill;
(f) behind the grill;
(g) on the hood;
(h) on the trunk;
(i) on the roof.

40. The method of claim 36 wherein at least one of said plurality of time-of-flight lidar sensors in said apparatus has the capability to be mounted at a wide range of angles.
